(19) United States
(12) Patent Application Publication
(10) Pub. No.: US 2026/0222463 A1
(43) Pub. Date: Jul. 30, 2026

(54) COMPLEXITY REDUCTION IN MULTI-STREAM AUDIO

(71) Applicant: Nokia Technologies Oy, Espoo (FI)

(72) Inventor: Lasse Juhani Laaksonen, Tampere (FI)

(21) Appl. No.: 19/141,374

(22) PCT Filed: Nov. 10, 2023
(86) PCT No.: PCT/FI2023/050625

§ 371 Date: Jun. 20, 2025

(30) Foreign Application Priority Data
Dec. 22, 2022 (FI) 20226154

(51) Int. Cl. H04L 65/65; H04L 65/403

(52) U.S. Cl. CPC H04L 65/65; H04L 65/403

(57) ABSTRACT

A method including: obtaining at least one audio stream for a multi-stream audio transmission; obtaining an indication relating to importance of said at least one audio stream in said multi-stream audio transmission; determining, based on at least said indication, an importance value for said at least one audio stream; including said at least one audio stream in payloads of a plurality of RTP packets and said importance value in headers of said RTP packets; and transmitting said at least one audio stream to one or more apparatus participating in said multi-stream audio transmission.

### TECHNICAL FIELD

The present invention relates to reducing complexity in multi-stream audio environment, especially in immersive audio.

### BACKGROUND

The current audio codec development, such as the 3GGP IVAS codec, is intended for new immersive voice and audio services over various network technologies, including 4G LTE (long-term evolution) and 5G NR (new radio). Such immersive services include, e.g., immersive voice and audio for communication and augmented/virtual/extended reality (AR/VR/XR). Another example of immersive services is a conference call allowing positioning of other participants around the listener in an audio scene.

However, the immersive nature of multi-party conferencing, and any other similar multi-stream transmission, increases the burden for decoding, as well as for rendering, when several streams are being delivered. The IVAS codec is expected to support more than one audio format used as the inputs, i.e. component signals, to the coding process (using one or more encoders). At the receiving end, each of the component signals for the final rendering need to be decoded separately, rendered, and combined. Thus, a plurality of decoder instances typically need to be activated. The shift from using one decoder instance to two decoder instances doubles the computational complexity on average, and a further shift from two decoder instances, for example, to four decoder instances may be expected to create a further double increase on the computational complexity. Thus, the effect is very significant.

On the other hand, it may be assumed that not all audio streams are important at all times. Thus, there is need for a method for reducing complexity in audio stream processing.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for obtaining at least one audio stream for a multi-stream audio transmission; means for obtaining an indication relating to importance of said at least one audio stream in said multi-stream audio transmission; means for determining, based on at least said indication, an importance value for said at least one audio stream; means for including said at least one audio stream in payloads of a plurality of real-time transport protocol packets and said importance value in headers of said real-time transport protocol packets; and means for transmitting said at least one audio stream to one or more apparatus participating in said multi-stream audio transmission.

According to an embodiment, the importance value is provided with a range of values configured to indicate at least one value for an important stream and at least one value for an unimportant stream.

According to an embodiment, the importance value is configured to indicate a plurality of values for different importance of a stream.

According to an embodiment, the importance value is configured to indicate an absolute importance of a stream.

According to an embodiment, the importance value is configured to indicate a relative importance of a stream among streams of the multi-stream audio transmission.

According to an embodiment, the apparatus comprises means for transmitting said importance value using an real-time transport protocol header extension.

According to an embodiment, the apparatus comprises means for including, in said real-time transport protocol header extension, information about jointly coded plurality of audio inputs.

According to an embodiment, the apparatus comprises means for obtaining said indication relating to the importance of said at least one audio stream from one or more of the following: a user input, an application input, a service input, or a device input.

A method according to a second aspect comprises obtaining at least one audio stream for a multi-stream audio transmission; obtaining an indication relating to importance of said at least one audio stream in said multi-stream audio transmission; determining, based on at least said indication, an importance value for said at least one audio stream; including said at least one audio stream in payloads of a plurality of real-time transport protocol packets and said importance value in headers of said real-time transport protocol packets; and transmitting said at least one audio stream to one or more apparatus participating in said multi-stream audio transmission.

An apparatus according to a third aspect comprises at least one processor and at least one memory, said at least one memory stored with computer program code thereon, the at least one memory and the computer program code configured to, with the at least one processor, cause the apparatus at least to perform: obtain at least one audio stream for a multi-stream audio transmission; obtain an indication relating to importance of said at least one audio stream in said multi-stream audio transmission; determine, based on at least said indication, an importance value for said at least one audio stream; include said at least one audio stream in payloads of a plurality of real-time transport protocol packets and said importance value in headers of said real-time transport protocol packets; and transmit said at least one audio stream to one or more apparatus participating in said multi-stream audio transmission.

According to a fourth aspect, there is provided an apparatus comprising means for receiving at least one audio stream in payloads of a plurality of real-time transport protocol packets; means for obtaining an importance value for said at least one audio stream from headers of said real-time transport protocol packets; and means for determining, based on at least said importance value, one or more parameters defining processing of said at least one audio stream for a multi-stream audio transmission.

According to an embodiment, the apparatus comprises means for setting decoding of at least one audio stream with a lower importance value to an inactive state.

According to an embodiment, the apparatus comprises means for obtaining at least one transmission parameter value; means for comparing the at least one transmission parameter value to a corresponding transmission parameter value of the at least one audio stream; and means for determining, based on the at least one importance value and at least one transmission parameter value, a processing option for the at least one audio stream.

According to an embodiment, said processing option comprises at least one of the following:
forwarding the at least one audio stream as such to a receiver;
encoding the at least one audio stream and packetizing the encoded audio stream for transmission to a receiver.

According to an embodiment, said apparatus is an audio conference server or bridge.

A method according to a fifth aspect comprises receiving at least one audio stream in payloads of a plurality of real-time transport protocol packets; obtaining an importance value for said at least one audio stream from headers of said real-time transport protocol packets; and determining, based on at least said importance value, one or more parameters defining processing of said at least one audio stream for a multi-stream audio transmission.

An apparatus according to a sixth aspect comprises at least one processor and at least one memory, said at least one memory stored with computer program code thereon, the at least one memory and the computer program code configured to, with the at least one processor, cause the apparatus at least to perform: receive at least one audio stream in payloads of a plurality of real-time transport protocol packets; obtain an importance value for said at least one audio stream from headers of said real-time transport protocol packets; and determine, based on at least said importance value, one or more parameters defining processing of said at least one audio stream for a multi-stream audio transmission.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIGS. 1a and 1b show examples of multi-party conferencing implementations as a server-based approach and a peer-to-peer approach, respectively;

FIG. 2 shows an exemplified situation, where the input of the multi-stream codec includes four different component signals;

FIG. 3 show a flow chart for indicating an importance of an audio stream according to an embodiment;

FIG. 4 show a flow chart for determining an importance of a received audio stream according to an embodiment;

FIG. 5 shows a transmission side example of a teleconferencing server receiving at least two audio streams according to an embodiment;

FIG. 6 shows a receiving side example, where the transmission configuration shown in FIG. 5 is received according to the embodiments;

FIG. 7 show a flow chart of an example decoding method according to an embodiment; and

FIG. 8 show a flow chart of an example processing method according to an embodiment.

### DETAILED DESCRIPTION OF SOME EXAMPLE EMBODIMENTS

The 3GGP IVAS (Immersive Voice and Audio Services) codec is an extension of the 3GPP EVS (Enhanced Voice Services) codec and intended for new immersive voice and audio services over contemporary and future communication networks, such as 4G LTE (long-term evolution), 5G NR (new radio) and 6G networks. Such immersive services include, e.g., immersive voice and audio for augmented/virtual/extended reality (AR/VR/XR). The multi-purpose audio codec is expected to handle the encoding, decoding and rendering of speech, music and generic audio. It is expected to support channel-based audio and scene-based audio inputs including spatial information about the sound field and sound sources. It is also expected to operate with low latency to enable conversational services as well as support high error robustness under various transmission conditions.

Immersive audio capture and encoding can be realized e.g. through a microphone capture processing or an equivalent pre-processing, which generates the input signals based on a multi-microphone mobile device audio capture, Ambisonics capture, or any other relevant capture. In addition, audio files may also be used to provide at least a part of the input to the codec. The input signals are presented to the IVAS encoder in at least one of the supported audio formats, but the IVAS encoder may process a plurality of various allowed combinations of audio formats as inputs.

One of the audio formats supported by the IVAS encoder is the Metadata-Assisted Spatial Audio (MASA) audio format. MASA audio format consists of channels and spatial metadata. For example, there can be one or two channels (mono, stereo) and spatial metadata. Directional parameters of audio sources, such as their azimuth and elevation, and energy ratio(s) obtained through a multi-channel analysis in time-frequency domain are used to represent the spatial metadata. On the other hand, the directional metadata for individual audio sources and audio objects may be processed in a separate processing chain.

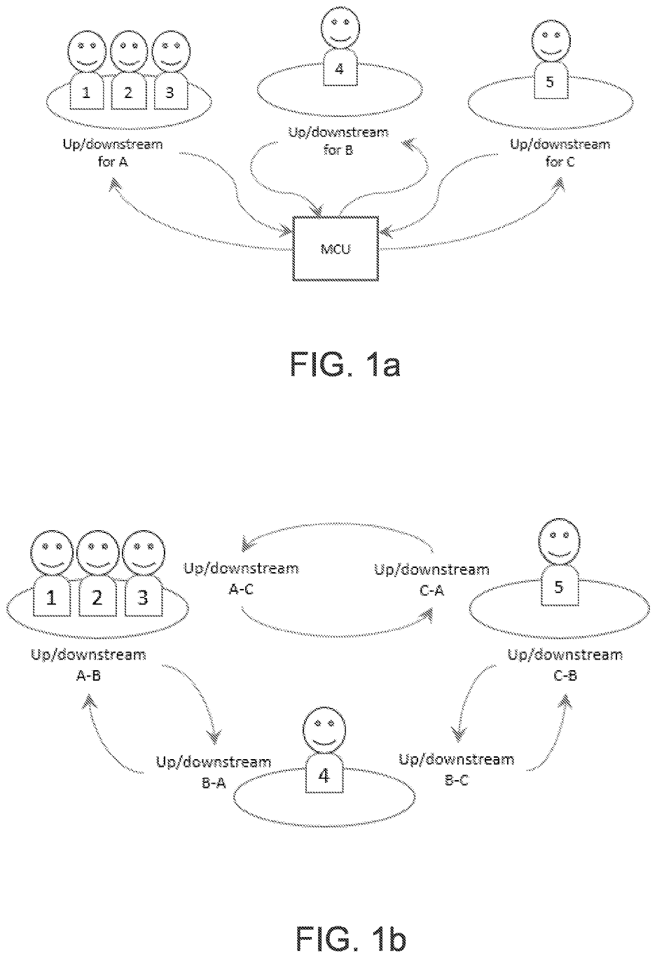

One important use case for modern communications codecs, including IVAS, is multi-party conferencing. In general, the multi-party conferencing may be implemented using a server-based approach, as shown in FIG. 1a, or a peer-to-peer approach, as shown in FIG. 1b. In the server-based approach, a conferencing server/bridge, such as a Multipoint Control Unit (MCU), controls the delivery and mixing of the upstream and downstream audio signals between the participant sites A, B and C. Each participant site may have one or more users and one or more audio signal sources.

In the peer-to-peer approach, each participant site has a direct connection with each of other participant sites for delivering the upstream and downstream audio signals, and the mixing of the signals from different sites is carried out by the apparatus at the participant site.

Traditional voice conferencing provides a mono upstream signal and mono downstream signal between the connections (server or peer-to-peer). Mono upstream signal and stereo (or other spatialization) downstream signal is also becoming a common option. With IVAS, each upstream and downstream signal may be spatial and thus comprise several audio sources distinguishable by their directions. As mentioned above, there may be more than one audio format used as the inputs to the coding process (using one or more encoders), for example, two mono audio objects and a MASA ambience signal describing an overall spatial audio scene.

The upstream and downstream signals may be transmitted, in both the server-based approach as well as the peer-to-peer approach, using Real Time Transport Protocol (RTP). RTP is intended for an end-to-end, real-time transfer or streaming media and provides facilities for jitter compensation and detection of packet loss and out-of-order delivery. RTP allows data transfer to multiple destinations through IP multicast or to a specific destination through IP unicast. The majority of the RTP implementations are built on the User Datagram Protocol (UDP). Other transport protocols may also be utilized. RTP is used in together with other protocols such as H.323 and Real Time Streaming Protocol RTSP.

The RTP specification describes two protocols: RTP and RTCP. RTP is used for the transfer of multimedia data, and the RTCP is used to periodically send control information and QoS parameters.

RTP sessions may be initiated between client and server using a signalling protocol, such as H.323, the Session Initiation Protocol (SIP), or RTSP. These protocols may use the Session Description Protocol (RFC 8866) to specify the parameters for the sessions.

RTP is designed to carry a multitude of multimedia formats, which permits the development of new formats without revising the RTP standard. To this end, the information required by a specific application of the protocol is not included in the generic RTP header. For a class of applications (e.g., audio, video), an RTP profile may be defined. For a media format (e.g., a specific video coding format), an associated RTP payload format may be defined. Every instantiation of RTP in a particular application may require a profile and payload format specifications.

The profile defines the codecs used to encode the payload data and their mapping to payload format codecs in the protocol field Payload Type (PT) of the RTP header.

For example, RTP profile for audio and video conferences with minimal control is defined in RFC 3551. The profile defines a set of static payload type assignments, and a dynamic mechanism for mapping between a payload format, and a PT value using Session Description Protocol (SDP). IVAS RTP payload and signaling, in turn, will be specified in 3GPP TS 26.253, which is expected to provide the detailed algorithmic description of the IVAS codec including its RTP payload format and SDP parameter definitions.

An RTP session is established for each multimedia stream. Audio (and video) streams may use separate RTP sessions, enabling a receiver to selectively receive components of a particular stream. The RTP specification recommends even port number for RTP, and the use of the next odd port number of the associated RTCP session. A single port can be used for RTP and RTCP in applications that multiplex the protocols.

Each RTP stream consists of RTP packets, which in turn consist of RTP header and payload parts.

Session Description Protocol (SDP) is a format for describing multimedia communication sessions for the purposes of announcement and invitation. Its predominant use is in support of conversational and streaming media applications. SDP does not deliver any media streams itself, but it is used between endpoints for negotiation of network metrics, media types, and other associated properties. The set of properties and parameters is called a session profile. SDP is extensible for the support of new media types and formats.

The new audio codec features can significantly improve the user experience, since the inherent audio quality is very high, better immersion is created, and manipulation of the audio scene becomes possible by controlling the position, orientation, and relative volume levels of individual sources at the renderer.

Immersive multi-party conferencing and other multi-stream use cases will be important for the upcoming 3GPP IVAS codec. The codec is expected to be used on a wide range of UEs including devices with more constraints in terms of complexity and battery life, such as connected (audio) headsets, earbuds, etc.

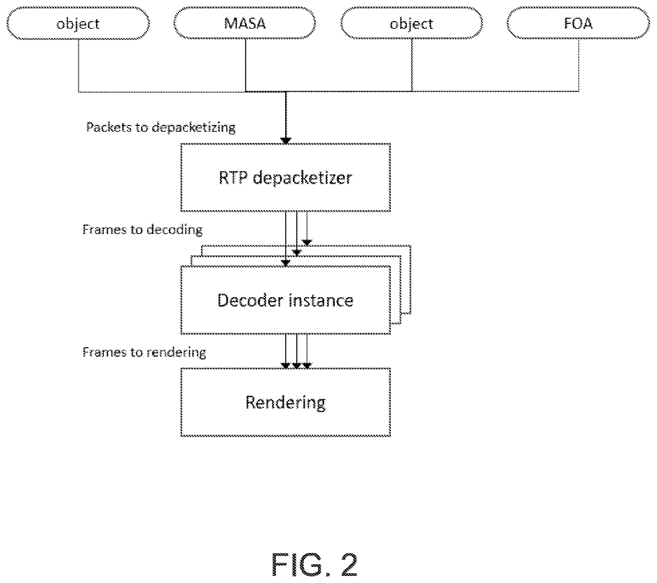

However, the immersive nature of multi-party conferencing, and any other similar multi-stream transmission, increases the burden for decoding, as well as for rendering, when several streams are being delivered. FIG. 2 illustrates an exemplified situation, where the input of the codec includes 4 different component signals, i.e. two mono audio object signals, a MASA ambience signal and a First-Order Ambisonics (FOA) signal. Each of the component signals for the final rendering need to be decoded separately, rendered, and combined. Thus, in this example at least three, possibly four decoder instances need to be activated. The shift from one decoder instance to two decoder instances doubles the computational complexity on average. The shift from two decoder instances to four decoder instances may be expected to again double the computational complexity. Thus, the effect is very significant.

On the other hand, it may be assumed that not all audio streams are important at all times.

In the following, enhanced methods for enabling to decrease computational complexity in audio signal processing and/or decoding will be described in more detail, in accordance with various embodiments.

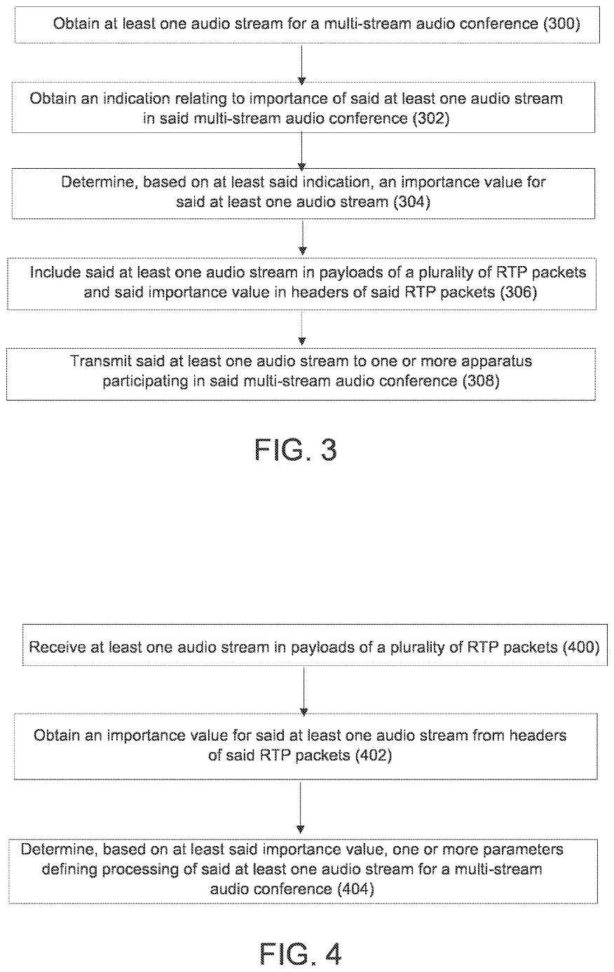

A method, which is disclosed in FIG. 3, comprises obtaining (300) at least one audio stream for a multi-stream audio transmission; obtaining (302) an indication relating to importance of said at least one audio stream in said multi-stream audio transmission; determining (304), based on at least said indication, an importance value for said at least one audio stream; including (306) said at least one audio stream in payloads of a plurality of real-time transport protocol packets and said importance value in headers of said real-time transport protocol packets; and transmitting (308) said at least one audio stream to one or more apparatus participating in said multi-stream audio transmission.

Thus, the method stems from the fact that all audio streams are not necessarily important at all times in a multi-stream audio transmission, such as in an audio conference. Consequently, by determining an importance value of an audio stream and including the importance value in headers of the RTP packets carrying said audio stream enables the receiving side, whether it is a conference server/bridge or another participant apparatus of the multi-stream audio transmission, to process the audio stream according to its importance, and thereby, for example, reduce the computational complexity of the decoding.

Another aspect relates to processing of such audio streams upon receiving, wherein the method comprises, as shown in FIG. 4, receiving (400) at least one audio stream in payloads of a plurality of real-time transport protocol packets; obtaining (402) an importance value for said at least one audio stream from headers of said real-time transport protocol packets; and determining (404), based on at least said importance value, one or more parameters defining processing of said at least one audio stream for a multi-stream audio transmission.

Hence, based on the audio stream-specific importance value, the receiving apparatus may define appropriate processing for said audio stream.

In the following, the embodiments are described in an exemplified manner by referring to audio conferencing as a suitable platform for implementing the methods and their embodiments. It is, however, noted that audio conferencing is only one, albeit a common example of multi-stream (spatial) audio transmission, receiving, decoding/rendering, but it is not the only relevant use case. Even in an one-to-one call there may be multiple streams transmitted, or a service could add at least one stream in some use cases.

According to an embodiment, the method comprises setting decoding of at least one audio stream with a lower importance value to an inactive state.

Thus, the computational complexity at the receiving side, e.g. at a UE, may be reduced by using fewer decoder and rendering instances without reducing quality of experience. Moreover, the complexity of the rendered audio scene may be reduced at the receiving UE by setting at least one lower-importance stream decoding to inactive state to help the listener focus on the more important audio scene components.

According to an embodiment, the importance value is provided with a range of values configured to indicate at least one value for an important stream and at least one value for an unimportant stream.

Thus, at simplest only two importance values may be used: one for indicating an important stream and another for indicating an unimportant stream. In a simple implementation example, the important stream may refer to a voice signal and the unimportant stream may refer to a non-voice signal.

According to an embodiment, the importance value is configured to indicate a plurality of values for different importance of a stream.

Providing a wider range of importance values enables a more versatile processing of the audio streams according to their importance.

According to an embodiment, the importance value is configured to indicate an absolute importance of a stream.

The absolute importance of a stream may be indicated by a plurality of code values. An absolute code indicates for each stream a specific importance value. The value can have an inherent meaning specifying the kind of content the stream currently carries. Providing the absolute values is always possible, since no knowledge of other streams of the multi-stream audio conference is required and defining the importance can be directly based on the source signal or an input from the user or service. For example, an active voice signal may be considered important by default in any communications scenario, whereas a silent channel can always be considered unimportant, since it will not affect the rendering anyway. Thus, providing the absolute values at simplest may implemented with only two code values.

According to an embodiment, the importance value is configured to indicate a relative importance of a stream among streams of the multi-stream audio conference.

The relative importance of a stream may also be indicated by a plurality of code values. A relative code indicates an order of importance for a set of streams (without necessarily specifying the set itself). Providing the relative values basically requires some knowledge of all streams. For example, a server-based architecture or sufficient side information transmission between nodes in a peer-to-peer architecture can be suitable for use of relative codes. Relative codes can be used for a subset of streams, while it would be understood that there remains ambiguity between streams in different subsets.

According to an embodiment, the method comprises transmitting said importance value using a real-time transport protocol header extension.

In the context of a multi-stream audio conference a single stream may also be referred to as a stream component. Setting the stream component importance in a codec-specific RTP Header, such as the IVAS RTP Header, can be achieved, for example, using the RTP header extension mechanism, as described in RFC 8285. The RTP header extension mechanism enables multiple identified extensions to be used in RTP packets, without the need for formal registration of the extensions but nonetheless avoiding collisions. The multiple header extension elements may be provided in a single RTP packet, wherein the extension elements are named by URIs. A Session Description Protocol (SDP) method may be used for mapping between the naming URIs and the identifier values carried in the RTP packets.

Herein, a one-byte or two-byte header may be used. The one-byte header format allows for data lengths between 1 and 16 bytes (maximum rate 6.4 kbps), while the two-byte header format has data lengths between 0 and 255 bytes (maximum rate 102 kbps). The RTP packet with an RTP header extension will indicate whether it uses one-byte or two-byte header extensions. In the following, the examples are described using the one-byte header format.

Each extension element begins with an identifier (ID) and a length value (len). In the following examples, len=0. In a first example, the stream component importance information can be encoded using the one-byte header format as follows:

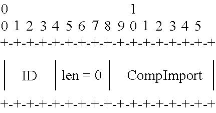

The stream component importance information (i.e. CompImport) is an 8-bit code (256 possible values) indicating the importance for stream ID. The stream may define at least a part of a spatial audio scene, and it includes at least one component. The importance value has thus been derived based on the highest importance for the current stream. The stream component importance information (i.e. CompImport) may be configured to indicate the absolute or the relative importance of a stream.

Tables 1 and 2 shows examples of field code values for CompImport for absolute importance values and relative importance values, respectively.

TABLE 1

| Code | Meaning | Comment |
|---|---|---|
| 0 | No importance set | Feature not used by sender |
| 1 | Highest importance | For example, active talker |
| 2 | 2nd highest importance | For example, secondary talker |
| . . . | | |
| N | Low importance | For example, ambience with DTX |
| . . . | | |
| 63 | Lowest importance | No signal |
| 64 | Reserved | |
| . . . | Reserved | |
| 255 | Reserved | |

TABLE 2

| Code | Meaning | Comment |
|---|---|---|
| 0 | No importance set | Feature not used by sender |
| 1 | Highest importance | Highest relative importance |
| . . . | | |
| 127 | Lowest importance | Lowest relative importance |
| 128 | Reserved | |
| . . . | Reserved | |
| 255 | Reserved | |

In these examples, only the first 64 and the first 128 values are used, respectively.

According to an embodiment, the method comprises including, in said real-time transport protocol header extension, information about jointly coded plurality of audio inputs.

Accordingly, in an alternative implementation, a specific Format-internal stream component importance flag, F, may be included in the RTP header extension. This flag has the value ‘0’ or ‘1’ and it indicates further classification within the codec payload. While CompImport (now reduced to 7 bits) indicates the overall stream importance, there can be additional information available that requires (at least partial) decoding of the payload. For example, a stereo signal could have different importance for the left (L) and the right (R) channels. For example, a stereo signal may consist of two (essentially) uncorrelated signals, where the L channel carries voice and R channel carries background audio. This information obviously cannot be used without first decoding said L and R channels, since access to the decoded channels is required to actually use them separately. Thus, by setting F=1 it can be indicated that further decisions are possible by decoding. The overall importance for the stream is carried by the 7-bit indicator corresponding to the first example above (resulting in 128 possible values instead of 256).

In this second example, the stream component importance information can be encoded using the one-byte header format as follows:

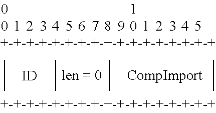

According to an embodiment, the method comprises obtaining said indication relating to the importance of said at least one audio stream from one or more of the following: a user input, an application input, a service input, or a device input.

The code values can be determined at any relevant device/node, but typically in the capturing/transmitting UE and the conferencing mixer/server. The decision about the code values may be based on factors such as user input, e.g., via a user interface on UE or conferencing application. For example, user can indicate on their device which one of the plurality of microphones used as input for a call is used for user's voice. Such microphone input (defining, for example, a channel that is part of a stream or a full stream) would be given a high default importance. On the other hand, the decision can be based also on signal analysis, e.g., signal or voice activity detection. Thus, at times, the voice input that has high importance by default could receive a lower importance setting due to inactivity. Such change may again be caused by a user input, e.g., muting of audio or a setting indicating absence.

In general, it can be expected that the stream component importance value is not updated very often during a call. Particularly, very large updates (e.g., from value ‘1’ to value ‘63’ in the above table) are typically not frequent.

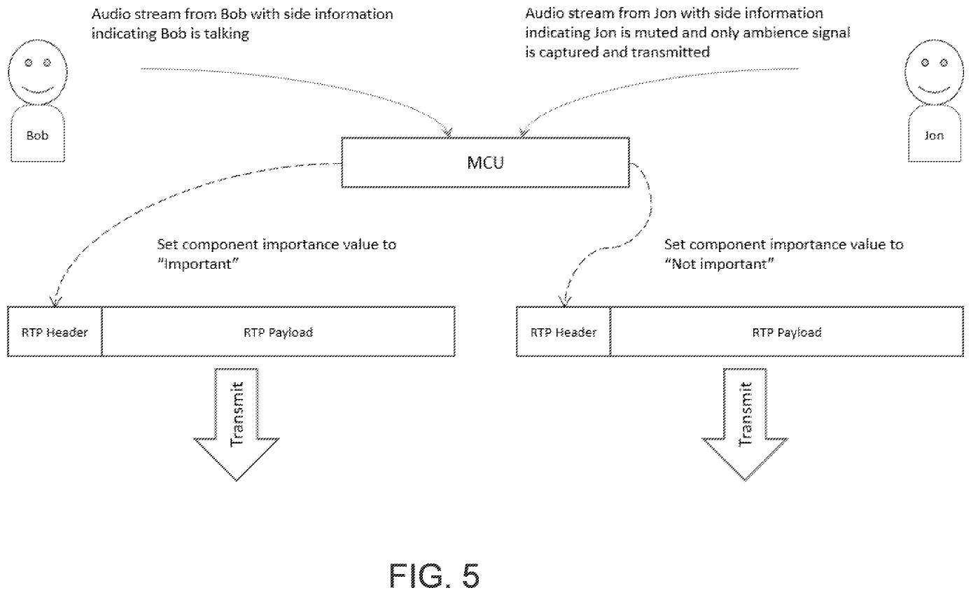

In the following, some use case examples are given for further illustrating the embodiments. FIG. 5 shows a transmission side example of a teleconferencing server, such as an MCU, receiving at least two audio streams with optional side information. Bob and Jon are the participants in a multi-user voice conferencing. The devices, such as UEs, used by Bob and Jon are both transmitting an audio stream to the server. Bob's audio stream has side information indicating that Bob is talking. The audio stream from Jon consists of two components: a voice stream, which is indicated by the side information to be muted (i.e. Jon's microphone is muted) and a room ambience signal, which is active.

Herein, the side information may serve as the indication relating to the importance of the audio stream. For example, the MCU may obtain the side information from a conferencing application run by the MCU. Alternatively, the MCU may obtain the side information as locally analysed by the UEs of Bob and Jon, respectively. In a further example, the MCU does not receive the side information, or it receives only partial side information, whereupon the MCU may run an audio analysis per component signal, either itself or assigned to performed, for example, in a cloud.

Based on the side information or the signal analysis, the MCU determines an importance value for each stream component (audio stream). The stream component importance value is set in the RTP header, and thereby transmitted to a receiving user. In this example, simple two values of “Important” and “Not important” are used here.

In an alternative example, Bob and Jon may be connected to the same UE, for example, a local conferencing system with multiple audio inputs. Therein, separate stream component importance value can be set for the different audio inputs, such as microphones, used by Bob and Jon, respectively. Accordingly, the stream component importance value can be set in any transmitting module or device.

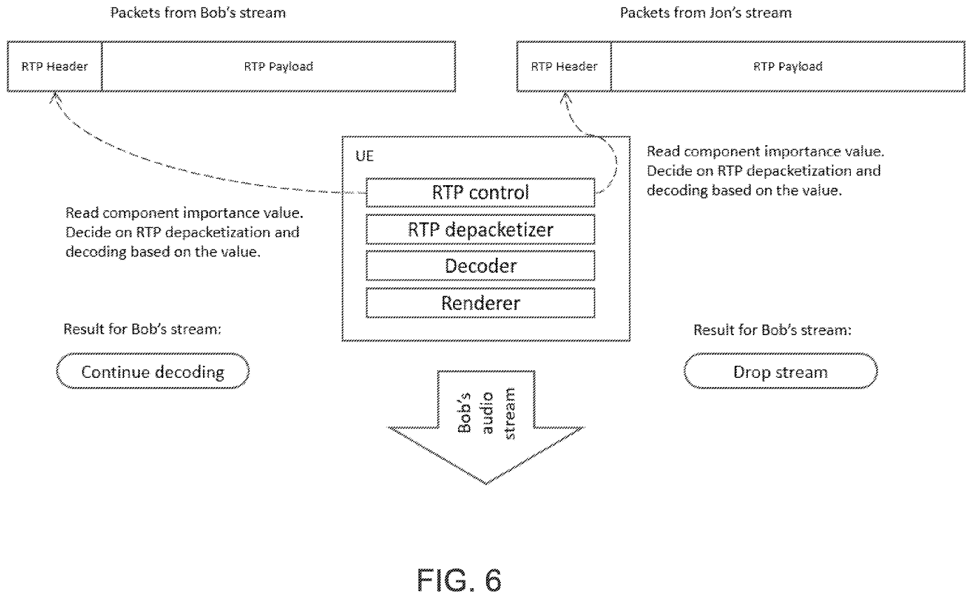

FIG. 6 shows a receiving side example, where the transmission configuration shown in FIG. 5 is received. A UE receives packets for Bob's audio stream and Jon's audio stream. A control module reads the RTP packet header and in this case specifically the information relating to stream component importance for each stream being received. The control module determines individually for each stream or together for the set of streams whether each stream will be decoded for rendering or not. The decision is based at least on the stream component importance value. Moreover, at least one additional input (e.g., a local input requesting to limit power consumption and thus number of decoder instances) may be used as a trigger for making the decision about decoding the stream.

Herein, Bob's stream, which is indicated as “Important”, will be decoded and rendered. Jon's audio stream will be dropped, and the decoder instance that would otherwise be required is not launched. The decoding complexity is thus reduced. However, dropping the audio stream from Jon completely will result in that the receiving user will neither hear the ambience audio from Jon.

Thus, upon receiving packets, the control unit reads from each RTP header at least the stream component importance value CompImport. In some embodiments, at least partially based on this value, the receiving UE can drop certain streams from a decoding queue (i.e., a decoder instance for a stream may be left uninitialized/may be closed/may be not used). This simplifies the decoding and rendering and therefore reduces the associated complexity significantly. On the other hand, at least one audio stream is then not part of the rendering.

If an audio stream of certain importance level was never to be decoded and rendered, there would obviously be no reason to transmit it either. With the aim of reducing the complexity of decoding and the audio scene, it can be specified that certain frames can be dropped at least partially based on the value of CompImport. In other words, a further condition may be typically assumed. Such condition can be an input from device, application, service, or user. If such condition is not fulfilled, all frames are decoded normally.

Generally, the first three inputs (device, application, service) relate to reduction of computational complexity, e.g., to save battery. The user input, and in some cases the application input, may also relate to reducing the complexity of the rendered scene. For example, a user may be listening to a conference call while doing something else, i.e. not especially focusing on the conference call. In this case, the user may wish to have as simple listening experience as possible. An easy way to achieve this is to remove less important audio streams, wherein the stream component importance value may be used to decide the less important audio streams.

In some cases, an application may receive information, e.g., about other ongoing audio presentation(s). The user could control the audio scene, e.g., by a slider or software button to simplify the scene. Some application implementations may take this into account and automatically reduce the complexity of the rendered audio scene to be more convenient for the user. At the same time, the computational load is reduced, as well.

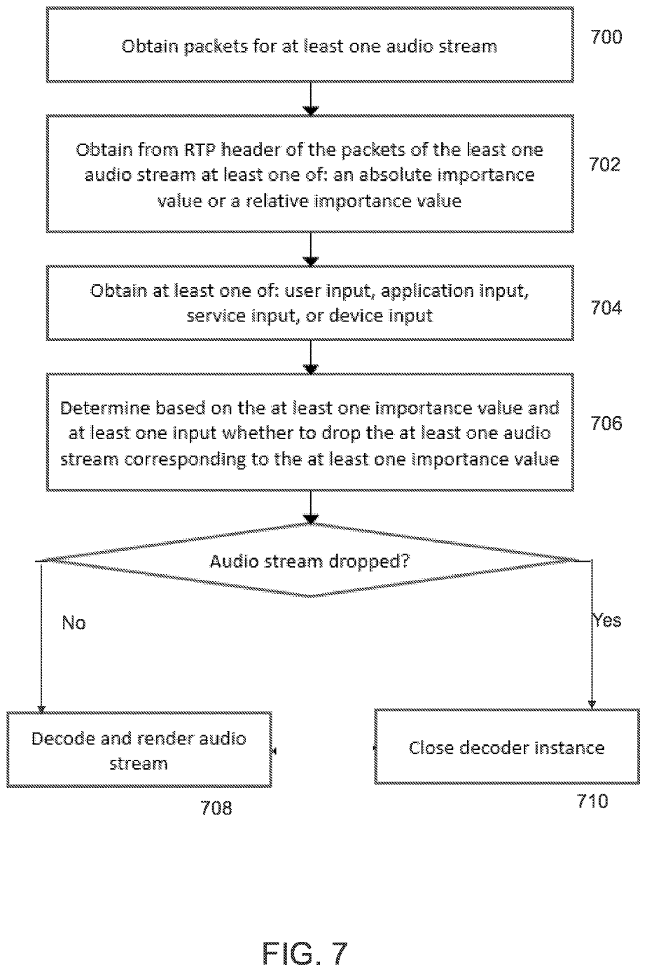

FIG. 7 presents a flow chart of an example decoding method, wherein a receiving apparatus, such as a UE, obtains (700) packets for at least one audio stream. It further obtains (702), from RTP header of the packets of the least one audio stream, at least one of: an absolute importance value or a relative importance value. As the further condition, the apparatus an input (704) as at least one of: user input, application input, service input, or device input. Then, based on the at least one importance value and at least one input, it is determined (706) whether to drop the at least one audio stream corresponding to the at least one importance value. If the audio stream is not dropped, it is decoded and rendered (708). If the audio stream is dropped, the corresponding decoder instance may be closed (710).

Some embodiments may be utilized to handle constraints, such as transmission constraints, in a conferencing scenario. For example, at least one audio source sends streams to a conferencing bridge (MCU), which can mix and re-encode or forward independent streams to at least one further party. At least one of the connections to the further parties may involve a bit rate limitation, e.g., due to network congestion. In this case, the MCU can process the content in one of two ways according to some of the above embodiments (or a combination thereof):
1) The MCU obtains the value of CompImport for each stream. The MCU obtains a value for the available constrained resource (e.g., total bit rate). The MCU determines an allocation of the streams into at least two categories: 1) stream forwarding for the higher-importance streams, and 2) re-encoding for the lower-importance streams. As a sub-category for the re-encoding, the re-encoding may entail audio downmix, i.e., at least two streams are first decoded, then mixed together, and only then re-encoded. Based on this processing, the available bit rate is allocated such that the more important streams are generally forwarded with original encoding quality, while the less important streams are generally compressed to a lower bit rate stream. The re-encoding also creates additional delay, which may or may not be compensated.
2) The MCU obtains the value of CompImport for each stream. The MCU obtains a value for the available constrained resource (e.g., total bit rate). The MCU determines allocation of the streams into at least two categories: 1) stream is transmitted to the receiver(s) for the higher-importance streams, and 2) stream is dropped for the lower-importance streams. This is a similar processing as considered previously for the UEs.

It is noted that both of the above methods also benefit from reduced complexity. Reductions are achieved at the conferencing bridge (fewer decoding and encoding operations) as well as the receiving UE (fewer streams need be decoded and rendered). Nevertheless, for the UEs, the intention is simply to allow the highest possible quality for the most important streams, when the transmission resources are constrained.

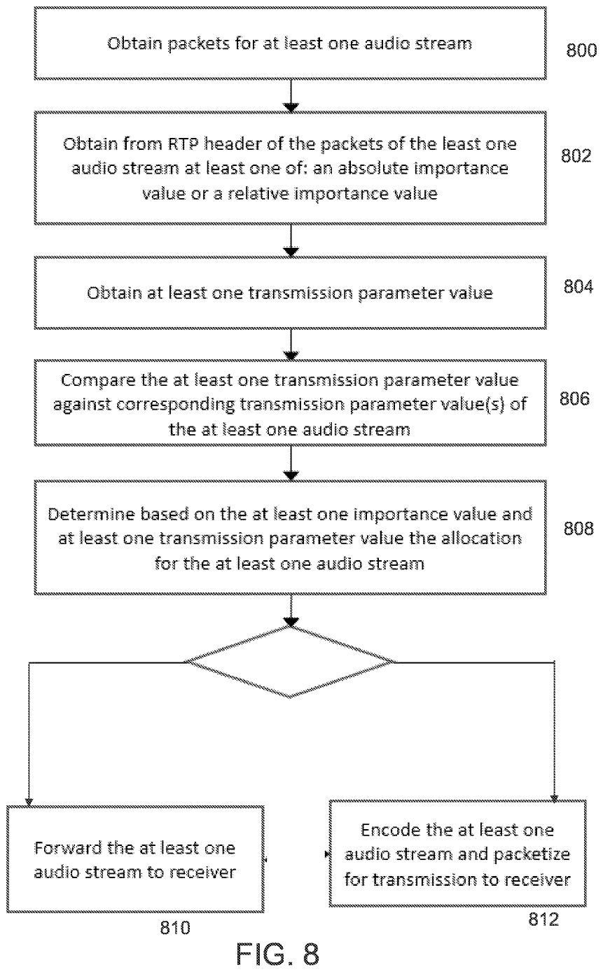

FIG. 8 presents a flow chart of an example processing method, where the processing unit can be, e.g., the MCU of FIG. 1. The processing unit obtains (800) packets for at least one audio stream. It also obtains (802), from RTP header of the packets of the least one audio stream, at least one of: an absolute importance value or a relative importance value. The processing unit further obtains (804) at least one transmission parameter value, which may be, for example, a total audio payload bit rate allocated for at least one of the downstreams. The processing unit compares (806) the at least one transmission parameter value against corresponding transmission parameter value(s) of the at least one audio stream. Then, based on the at least one importance value and at least one transmission parameter value, the allocation for processing the at least one audio stream is determined (808). The allocation for processing may result in forwarding the at least one audio stream as such to a receiver (810) or encoding the at least one audio stream and packetizing it for transmission to a receiver (812).

Consequently, the embodiments as described herein enable to reduce computational complexity at the receiving UE by allowing the receiving UE to set at least one lower-importance stream decoding to inactive state, leading to use of fewer decoder and rendering instances and therefore reduced computational load. Moreover, the complexity of the rendered audio scene may be reduced at the receiving UE by setting at least one lower-importance stream decoding to inactive state to help the listener focus on the more important audio scene components. Furthermore, audio stream mixing, encoding, and stream forwarding may be controlled at a receiving processing unit to allocate available bit rate without the need to individually decode and analyse each stream content.

An apparatus according to an aspect of the invention is arranged to implement the transmission side method as described above, and possibly one or more of the embodiments related thereto. Thus, the apparatus comprises means for obtaining at least one audio stream for a multi-stream audio conference; means for obtaining an indication relating to importance of said at least one audio stream in said multi-stream audio conference; means for determining, based on at least said indication, an importance value for said at least one audio stream; means for including said at least one audio stream in payloads of a plurality of real-time transport protocol packets and said importance value in headers of said real-time transport protocol packets; and means for transmitting said at least one audio stream to one or more apparatus participating in said multi-stream audio conference.

According to an embodiment, the importance value is provided with a range of values configured to indicate at least one value for an important stream and at least one value for an unimportant stream.

According to an embodiment, the importance value is configured to indicate a plurality of values for different importance of a stream.

According to an embodiment, the importance value is configured to indicate an absolute importance of a stream.

According to an embodiment, the importance value is configured to indicate a relative importance of a stream among streams of the multi-stream audio conference.

According to an embodiment, the apparatus comprises means for transmitting said importance value using a real-time transport protocol header extension.

According to an embodiment, the apparatus comprises means for including, in said real-time transport protocol header extension, information about jointly coded plurality of audio inputs.

According to an embodiment, the apparatus comprises means for obtaining said indication relating to the importance of said at least one audio stream from one or more of the following: a user input, an application input, a service input, or a device input.

An apparatus according to a further aspect comprises at least one processor and at least one memory, said at least one memory stored with computer program code thereon, the at least one memory and the computer program code configured to, with the at least one processor, cause the apparatus at least to perform: obtain at least one audio stream for a multi-stream audio conference; obtain an indication relating to importance of said at least one audio stream in said multi-stream audio conference; determine, based on at least said indication, an importance value for said at least one audio stream; include said at least one audio stream in payloads of a plurality of real-time transport protocol packets and said importance value in headers of said real-time transport protocol packets; and transmit said at least one audio stream to one or more apparatus participating in said multi-stream audio conference.

According to an embodiment, the importance value is provided with a range of values configured to indicate at least one value for an important stream and at least one value for an unimportant stream.

According to an embodiment, the importance value is configured to indicate a plurality of values for different importance of a stream.

According to an embodiment, the importance value is configured to indicate an absolute importance of a stream.

According to an embodiment, the importance value is configured to indicate a relative importance of a stream among streams of the multi-stream audio conference.

According to an embodiment, the apparatus comprises code configured to cause the apparatus to transmit said importance value using a real-time transport protocol header extension.

According to an embodiment, the apparatus comprises code configured to cause the apparatus to include, in said real-time transport protocol header extension, information about jointly coded plurality of audio inputs.

According to an embodiment, the apparatus comprises code configured to cause the apparatus to obtain said indication relating to the importance of said at least one audio stream from one or more of the following: a user input, an application input, a service input, or a device input.

An apparatus arranged to implement the receiving side method may comprise means for receiving at least one audio stream in payloads of a plurality of real-time transport protocol packets; means for obtaining an importance value for said at least one audio stream from headers of said real-time transport protocol packets; and means for determining, based on at least said importance value, one or more parameters defining processing of said at least one audio stream for a multi-stream audio conference.

According to an embodiment, the apparatus comprises means for setting decoding of at least one audio stream with a lower importance value to an inactive state.

According to an embodiment, the apparatus comprises means for obtaining at least one transmission parameter value; means for comparing the at least one transmission parameter value to a corresponding transmission parameter value of the at least one audio stream; and means for determining, based on the at least one importance value and at least one transmission parameter value, a processing option for the at least one audio stream.

According to an embodiment, said processing option comprises at least one of the following:
forwarding the at least one audio stream as such to a receiver;
encoding the at least one audio stream and packetizing the encoded audio stream for transmission to a receiver.

According to an embodiment, said apparatus is an audio conference server or bridge.

An apparatus according to a further aspect comprises at least one processor and at least one memory, said at least one memory stored with computer program code thereon, the at least one memory and the computer program code configured to, with the at least one processor, cause the apparatus at least to perform: receive at least one audio stream in payloads of a plurality of real-time transport protocol packets; obtain an importance value for said at least one audio stream from headers of said real-time transport protocol packets; and determine, based on at least said importance value, one or more parameters defining processing of said at least one audio stream for a multi-stream audio conference.

According to an embodiment, the apparatus comprises code configured to cause the apparatus to set decoding of at least one audio stream with a lower importance value to an inactive state.

According to an embodiment, the apparatus comprises code configured to cause the apparatus to obtain at least one transmission parameter value; compare the at least one transmission parameter value to a corresponding transmission parameter value of the at least one audio stream; and determine, based on the at least one importance value and at least one transmission parameter value, a processing option for the at least one audio stream.

According to an embodiment, the apparatus comprises code configured to cause the apparatus to process the at least one audio stream according to at least one of the following:
forwarding the at least one audio stream as such to a receiver;
encoding the at least one audio stream and packetizing the encoded audio stream for transmission to a receiver.

In the above, some embodiments have been described with reference to an encoder or an encoding method, it needs to be understood that the resulting bitstream and the decoder or the decoding method may have corresponding elements in them. Likewise, where the example embodiments have been described with reference to a decoder, it needs to be understood that the encoder may have structure and/or computer program for generating the bitstream to be decoded by the decoder.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1-17. (canceled)

18. An apparatus, comprising:
at least one processor; and
at least one memory storing instructions that, when executed with the at least one processor, cause the apparatus at least to:
obtain at least one audio stream for a multi-stream audio transmission;
obtain an indication relating to importance of the at least one audio stream of said multi-stream audio transmission;
determine, based on at least said indication, an importance value for the at least one audio stream;
include the at least one audio stream and said importance value in a bitstream; and
transmit said at least one audio stream and the importance value.

19. The apparatus according to claim 18, wherein the importance value is provided with a range of values configured to indicate at least one value for an important stream.

20. The apparatus according to claim 18, wherein the importance value is provided with a range of values configured to indicate at least one value for an unimportant stream.

21. The apparatus according to claim 18, wherein the importance value is configured to indicate a plurality of values for different importance of the at least one audio stream.

22. The apparatus according to claim 18, wherein the importance value is configured to indicate an absolute importance of the at least one audio stream.

23. The apparatus according to claim 18, wherein the importance value is configured to indicate a relative importance of the at least one audio stream among streams of the multi-stream audio transmission.

24. The apparatus according to claim 18, wherein the instructions, when executed with the at least one processor, cause the apparatus to transmit the importance value using a real-time transport protocol header extension.

25. The apparatus according to claim 24, wherein the instructions, when executed with the at least one processor, cause the apparatus to include, in said real-time transport protocol header extension, information about jointly coded plurality of audio inputs.

26. The apparatus according to claim 18, wherein the instructions, when executed with the at least one processor, cause the apparatus to obtain said indication relating to the importance of said at least one audio stream from at least one of:
a user input;
an application input;
a service input; or
or a device input.

27. The apparatus according to claim 18, wherein the instructions, when executed with the at least one processor, cause the apparatus to include the at least one audio stream in payloads of a plurality of real-time transport protocol packets.

28. The apparatus according to claim 27, wherein the instructions, when executed with the at least one processor, cause the apparatus to include said importance value in headers of said real-time transport protocol packets.

29. A method for transmitting, comprising:
obtaining at least one audio stream for a multi-stream audio transmission;
obtaining an indication relating to importance of the at least one audio stream of said multi-stream audio transmission;
determining, based on at least said indication, an importance value for the at least one audio stream;
including the at least one audio stream and said importance value in a bitstream; and
transmitting said at least one audio stream and the importance value.

30. An apparatus, comprising:
at least one processor; and
at least one memory storing instructions that, when executed with the at least one processor, cause the apparatus at least to:
receive at least one audio stream from a bitstream;
obtain an importance value for the at least one audio stream from the bitstream; and
determine, based on at least said importance value, one or more parameters defining processing of the at least one audio stream.

31. The apparatus according to claim 30, wherein the instructions, when executed with the at least one processor, further cause the apparatus to set decoding of at least one audio stream with a lower importance value to an inactive state.

32. The apparatus according to claim 30, wherein the instructions, when executed with the at least one processor, cause the apparatus to:
obtain at least one parameter value;
compare the at least one parameter value to a corresponding parameter value of the at least one audio stream; and
determine, based on the compared at least one importance value and the corresponding parameter value, a processing option for the at least one audio stream.

33. The apparatus according to claim 32, wherein said processing option comprises at least one of:
forwarding the at least one audio stream to a receiver;
encoding the at least one audio stream; or
packetizing the encoded at least one audio stream for transmission to a receiver.

34. The apparatus according to claim 33, wherein said apparatus is an audio conference server or bridge.

35. The apparatus according to claim 30, wherein the instructions, when executed with the at least one processor, cause the apparatus to receive the at least one audio stream in payloads of a plurality of real-time transport protocol packets.

36. The apparatus according to claim 35, wherein the instructions, when executed with the at least one processor, cause the apparatus obtain the importance value for the at least one audio stream from headers of said real-time transport protocol packets.

37. A method for receiving, comprising:
receiving at least one audio stream from a bitstream;
obtaining an importance value for the at least one audio stream from the bitstream; and
determining, based on at least said importance value, one or more parameters defining processing of the at least one audio stream.
